(19) United States
(12) Patent Application Publication
(10) Pub. No.: US 2014/0052938 A1
(43) Pub. Date: Feb. 20, 2014

(54) Clumsy Flow Control Method and Apparatus for Improving Performance and Energy Efficiency in On-Chip Network

(71) Applicant: KOREA ADVANCED INSTITUTE OF SCIENCE AND TECHNOLO, Daejeon (KR)

(72) Inventors: John Kim, Daejeon (KR); Hanjoon Kim, Daejeon (KR); Yonggon Kim, Daejeon (KR)

(73) Assignee: Korea Advanced Institute of Science and Technology, Daejeon (KR)

(21) Appl. No.: 13/672,023

(22) Filed: Nov. 8, 2012

(30) Foreign Application Priority Data
Aug. 14, 2012 (KR) 1020120088680

(51) Int. Cl. G06F 12/00

(52) U.S. Cl. CPC G06F 12/00
USPC 711/154

(57) ABSTRACT

A method and apparatus for increasing performance and energy-efficiency in an on-chip network are provided. A credit-based flow control method may include generating, in a core, a memory access request, throttling an injection of the memory access request until credits become available, and injecting the memory access request into a memory controller (MC) via an on-chip network, when the credits become available.

### CROSS-REFERENCE TO RELATED APPLICATION

This application claims the benefit of Korean Patent Application No. 10-2012-0088680, filed on Aug. 14, 2012, in the Korean Intellectual Property Office, the disclosure of which is incorporated herein by reference.

### BACKGROUND

1. Field of the Invention

The present invention relates to a method and apparatus for improving performance and energy efficiency in an on-chip network. This research was supported by the SW Computing R&D Program of KEIT(2011-10041313, UX-oriented Mobile SW Platform) funded by the Ministry of Knowledge Economy.

2. Description of the Related Art

An on-chip network router may function to receive, from an input port, a flit (flow control digit) that is a flow control unit of a packet, and to transfer the received flit to an output port along a routing path of the packet. Flow control manages the allocation of resources to packets along their route and resolves contentions. There can be several flow control mechanisms including bufferless and buffered. When contention occurs, buffered flow control temporarily stores blocked packets in the buffer, while bufferless flow control misroute these packets.

For on-chip networks with both flow control mechanisms, when a high load is applied to an on-chip network, the on-chip network may experience network congestion, and packets contend for shared network resources frequently, and thus may reduce overall performance.

For a bufferless on-chip network, when a high load is applied and a number of contentions between packets is increased, and a large number of packets may be deflected, which may lead to a reduction in performance of the bufferless on-chip network. Additionally, due to the deflected packets, an energy reduction effect that may be obtained by the bufferless on-chip network may be reduced.

### SUMMARY

An aspect of the present invention provides a credit-based flow control method and apparatus that may improve performance of a router by reducing a number of contentions in an on-chip network.

According to an aspect of the present invention, there is provided a credit-based flow control method, including: generating, in a core, a memory access request; throttling an injection of the memory access request until credits become available; and injecting the memory access request into a memory controller (MC) via an on-chip network, when the credits become available.

The credits may represent approximate availability of a destination buffer at a destination of the memory access request, and the destination buffer may represent a memory access request queue of the MC.

The clumsy represents that present invention may use the inexact or approximate number of credit for destination buffer to improve performance and energy-efficiency. A credit count may be set, and may be set automatically or manually based on a required performance.

The generating of the memory access request may include generating a memory read request and a memory write request during a program. A credit for the memory read request and a credit for the memory write request may be individually maintained.

A credit count may be decremented once a memory access request is injected into the MC, and a number of available credits may be increased once a reply to the memory access request is generated and transferred from the MC to the core.

According to another aspect of the present invention, there is provided a credit-based flow control apparatus, including: a core; and an MC. When a memory access request is generated in the core, an injection of the memory access request may be throttled until credits become available. When the credits become available, the memory access request may be injected into an MC via an on-chip network.

### EFFECT

According to embodiments of the present invention, a manycore accelerator architecture in which a high load is applied to an on-chip network may be applied to a bufferless on-chip network, and accordingly it is possible to obtain performance similar to performance of a buffered on-chip network, and simultaneously to improve an energy efficiency of the bufferless on-chip network.

Additionally, according to embodiments of the present invention, it is possible to be applied to a buffered on-chip network, and accordingly it is possible to improve performance by reducing contention in the network.

Additionally, according to embodiments of the present invention, it is possible to provide a credit-based flow control method and apparatus that may be applied to a design of an on-chip network of a manycore processor.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a credit flow and a data flow in a conventional buffered on-chip network;

FIG. 2 is a flowchart illustrating a clumsy flow control method according to embodiments of the present invention;

FIG. 3 is a diagram illustrating an overall operation algorithm of a credit-based flow control method according to embodiments of the present invention; and

FIG. 4 is a diagram illustrating a clumsy flow control apparatus and a data flow according to embodiments of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a clumsy flow control method and apparatus will be described in detail with reference to the accompanying drawings.

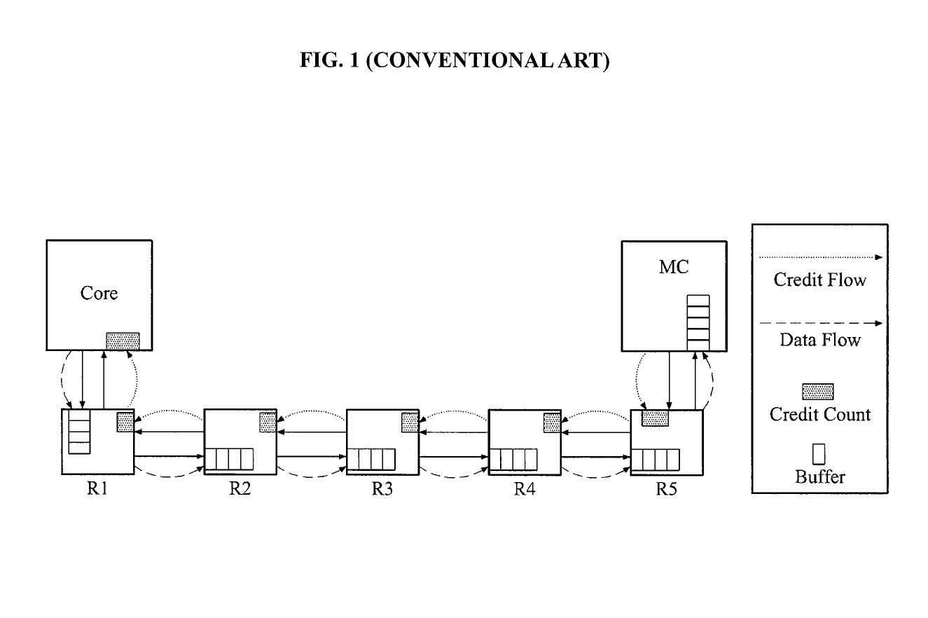

In an existing buffered on-chip network of FIG. 1, a credit represents availability of an input buffer of a next router in a routing path, and a router may determine, based on the credit, whether a flit (namely, a flow control unit of a packet) is enabled to be transferred to the next router. In a flow of a packet as shown in FIG. 1, the packet may basically move by hopping, and may be transmitted or not based on whether a corresponding buffer exists.

In the present invention, a credit may represent approximate availability of a buffer at a destination, and accordingly the present invention may provide a clumsy flow control method and apparatus.

In embodiments of the present invention, a number of memory access requests may be limited by a proposed credit, and accordingly a number of memory access requests that may be transferred in a network may be limited. Thus, a number of contentions in an on-chip network and a number of times deflection routing occurs may be reduced.

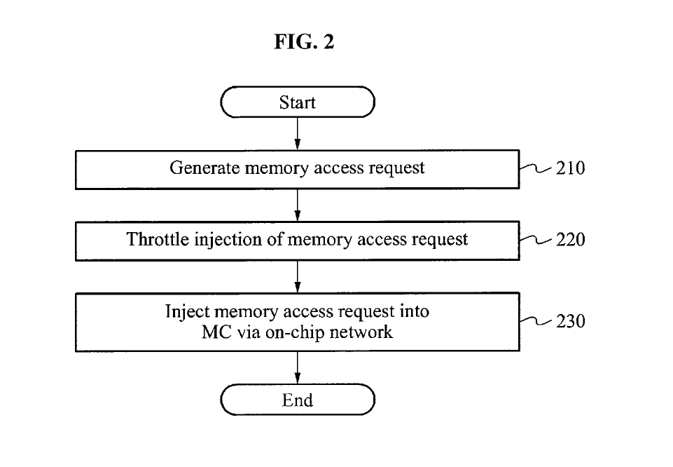

FIG. 2 is a flowchart illustrating a clumsy flow control method according to embodiments of the present invention.

In operation 210, a memory access request may be generated in a core. The memory access request may be injected into a memory controller (MC). However, when a credit used to transfer the memory access request is unavailable, injection of the memory access request into the MC may be throttled until the credit becomes available in operation 220.

Conversely, when the credit is available, the memory access request may be injected into the MC via an on-chip network in operation 230. In a structure of the present invention, traffic from the core to the MC may occur, and the memory access request may be adjusted by setting a credit count and by adjusting an amount of traffic in the on-chip network.

The credit count may be set based on situations. In an example, when it is difficult to quickly process a request using a small number of credits due to a large number of memory access requests, the credit count may be incremented. In another example, when credit-based flow control performance is regarded to be more important, a low credit count may be limited, or may be automatically or manually set based on a required performance.

As described above, a credit in the present invention may represent approximate availability of a destination buffer at a destination of a memory access request, that is, each credit may represent ability for each core to inject a memory access request into a network. Additionally, the destination buffer may represent a memory access request queue of the MC.

According to embodiments, the memory access request generated in operation 210 may be classified into a memory read request and a memory write request, and accordingly each core may classify credits into two credit types for each MC that is a destination, and may maintain a credit count.

Additionally, available credits may indicate that a number of available credits exist. Since a credit is used every time a memory access request is injected into an MC, a number of available credits may be reduced. Conversely, when a memory access request is injected into an MC, and when a reply to the memory access request is generated and transferred from the MC to a core, the memory access request may be completed, and a number of available credits may be increased.

In other words, when a credit is unavailable, injection of a memory access request may be throttled until the credit becomes available. When the credit becomes available since the memory access request is completed, the memory access request may be injected into an MC.

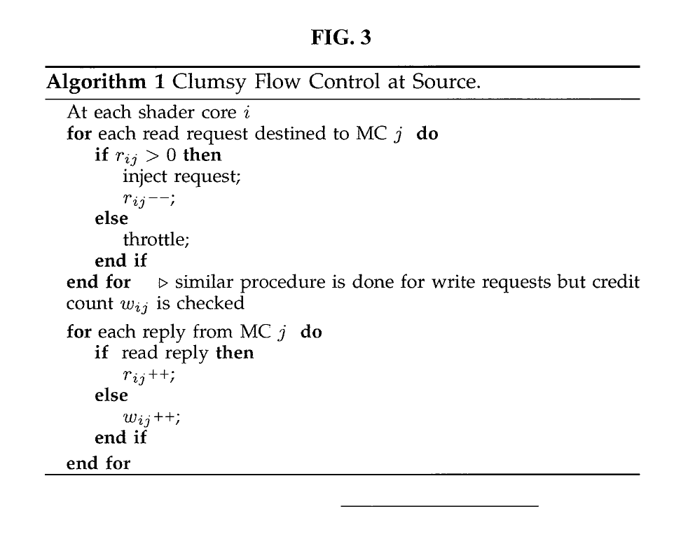

FIG. 3 is a diagram illustrating an operation algorithm of a credit-based flow control method according to embodiments of the present invention. As described above, each core may individually maintain two credits, namely, a credit for a memory read request and a credit for a memory write request, for each MC that is a destination.

Referring to FIG. 3, rᵢⱼ denotes a credit count associated with a buffer of an MC j allocated to a core i, in response to a read request, and wᵢⱼ denotes a credit count associated with the buffer of the MC j allocated to the core i, in response to a write request. Additionally, when there is no request, each core may have credits corresponding to r and w that are given initial credit counts.

For a memory read request, when rᵢⱼ>0, a core may inject the memory read request into an on-chip network, and rᵢⱼ may be decremented by ‘1.’ When rᵢⱼ=0, injection of the memory read request may be throttled until a credit becomes available, that is, until rᵢⱼ becomes greater than ‘0.’ When a reply to the memory read request returns from the MC j to the core i, rᵢⱼ may be incremented again by ‘1.’

For a memory write request, the above-described example may be applied. When wᵢⱼ>0, a core may inject the memory write request into an on-chip network, and wᵢⱼ may be decremented by ‘1,’ since a credit is available. Additionally, when wᵢⱼ=0, injection of the memory write request may be throttled until the credit becomes available, that is, until wᵢⱼ becomes greater than ‘0.’ When a reply to the memory write request returns from the MC j to the core i, wᵢⱼ may be incremented again by ‘1,’ and accordingly a number of available credits may be increased.

As values of r and w that are given as initial values decrease, contention may be reduced, and a number of memory access requests that may be transferred by each core may be reduced. Accordingly, overall performance may be limited. Additionally, as the values of r and w increase, an amount of traffic input to an on-chip network may be increased and accordingly, more contention may occur. In embodiments, a case in which the values of r and w approach infinity may correspond to an existing bufferless router without a credit-based flow control.

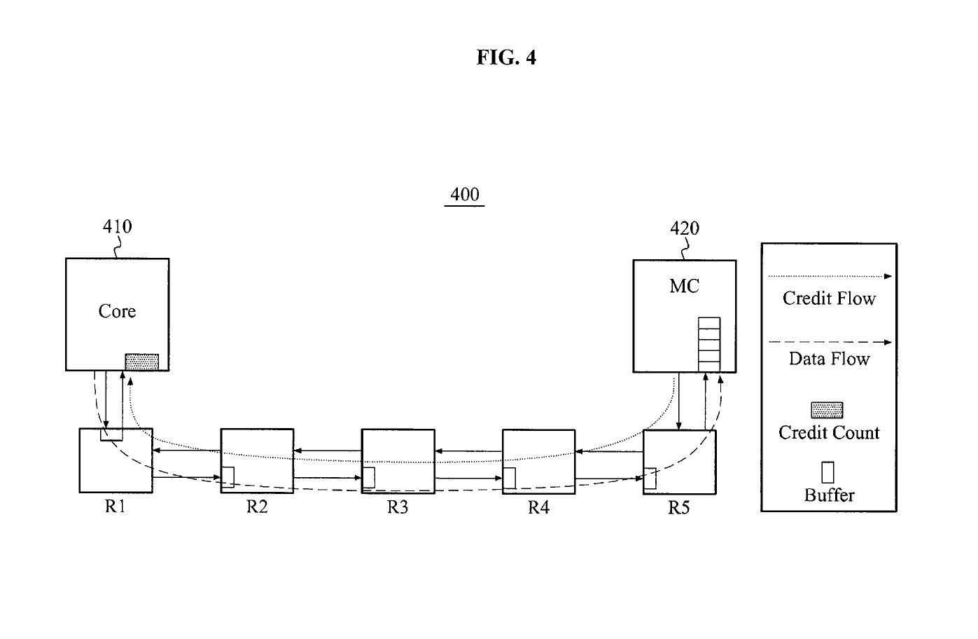

FIG. 4 is a diagram illustrating a structure of a credit-based flow control apparatus 400, a data flow, and a credit flow according to embodiments of the present invention. The credit-based flow control apparatus 400 of FIG. 4 may include a core 410 and an MC 420. The core 410 may generate a memory access request and may transfer the generated memory access request to a destination. The MC 420 may be a destination of the memory access request.

The credit-based flow control apparatus 400 may be used as an apparatus to perform the above-described credit-based flow control method, and each component of the credit-based flow control apparatus 400 may be replaced or changed by similar components. Additionally, in embodiments of the present invention, an effect and performance of the credit-based flow control apparatus 400 may be similarly exhibited, despite a change in each component of the credit-based flow control apparatus 400.

In embodiments of the present invention, a number of memory access requests may be limited by a proposed credit, and accordingly a number of memory access requests that may be transferred in a network may be limited. Thus, a number of contentions in an on-chip network. And for the bufferless on-chip network, a number of times deflection routing occurs may be reduced.

A credit proposed by the present invention may represent approximate availability of a destination buffer at a destination of a memory access request, and the destination buffer may represent a memory access request queue of an MC that is a destination of a memory access request. A queue may refer to queuing information to process an input request, or refer to a waiting line of information, since the input request randomly arrives.

A memory access request may be generated in the core 410, and may be injected into the MC 420. However, when a credit used to transfer the memory access request is unavailable, injection of the memory access request into the MC 420 may be throttled until the credit becomes available.

Conversely, when the credit is available, or when a state of the credit is changed from an unavailable state to an available state, the core 410 may inject the memory access request into the MC 420 via an on-chip network. In a structure of the present invention, traffic from the core 410 to the MC 420 may occur, and the memory access request may be adjusted by setting a credit count and by adjusting an amount of traffic in the on-chip network.

The memory access request generated in the core 410 may be classified into a memory read request and a memory write request, and accordingly the core 410 may maintain two credit counts for each MC 420 that is a destination.

For example, when a memory read request is generated, and when credits are unavailable, transmission of the memory read request may be throttled until the credits become available. When a reply to the memory read request is generated, the credits may become available, and the memory read request may be transmitted. Similarly, a memory write request may be processed.

In embodiments, an initial value of each of a credit for a memory read request and a credit for a memory write request, that is, an amount of traffic input to an on-chip network may be set. The initial value may be set for each of the memory read request and the memory write request, or may be set based on performance required by the credit-based flow control apparatus 400.

For example, when a low initial credit value is set, contention may be reduced, and a number of memory access requests that may be transferred by the core 410 may be reduced, and accordingly overall performance may be limited. Conversely, when a high initial credit value is set, an amount of traffic input to an on-chip network may be increased, and accordingly more contention may occur. In embodiments, a case in which a credit value approaches infinity may correspond to an existing bufferless router without a credit-based flow control.

As described above, according to embodiments of the present invention, it is possible to provide a credit-based flow control method and apparatus that may increase performance of a router by reducing a number of contentions in an on-chip network. For a case of applying the present invention to a bufferless router, by reducing a number of times deflection occurs through adjustment of an amount of on-chip network traffic, this may increase an energy-efficiency.

The clumsy flow control method according to the embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A credit-based flow control method, comprising:
generating, in a core, a memory access request;
throttling an injection of the memory access request until credits become available; and
injecting the memory access request into a memory controller (MC) via an on-chip network, when the credits become available.

2. The credit-based flow control method of claim 1, wherein the credits represent approximate availability of a destination buffer at a destination of the memory access request, and
wherein the destination buffer represents a memory access request queue of the MC.

3. The credit-based flow control method of claim 1, wherein a credit count is enabled to be set, and is enabled to be set automatically or manually based on a required performance.

4. The credit-based flow control method of claim 1, wherein the generating of the memory access request comprises generating a memory read request and a memory write request during a program, and
wherein a credit for the memory read request and a credit for the memory write request are individually maintained.

5. The credit-based flow control method of claim 1, wherein a credit count is decremented once a memory access request is injected into the NoC towards the MC, and
wherein a number of available credits is increased once a reply to the memory access request is generated and transferred from the MC to the core.

6. A credit-based flow control apparatus, comprising:
a core; and
a memory controller (MC),
wherein a memory access request is generated in the core,
wherein an injection of the memory access request is throttled until credits become available, and
wherein the memory access request is injected into an MC via an on-chip network, when the credits become available.

7. The credit-based flow control apparatus of claim 6, wherein the credits represent approximate availability of a destination buffer at a destination of the memory access request, and
wherein the destination buffer represents a memory access request queue of the MC.

8. The credit-based flow control apparatus of claim 6, wherein a credit count is enabled to be set, and is enabled to be set automatically or manually based on a required performance.

9. The credit-based flow control apparatus of claim 6, wherein a memory read request and a memory write request are generated in the core, and
wherein a credit for the memory read request and a credit for the memory write request are individually maintained.

10. The credit-based flow control apparatus of claim 6, wherein a credit count is decremented once a memory access request is injected from the core into the MC, and
wherein a number of available credits is increased once a reply to the memory access request is generated and transferred from the MC to the core.
